(19) United States
(12) Patent Application Publication
(10) Pub. No.: US 2009/0219723 A1
(43) Pub. Date: Sep. 3, 2009

(54) BRIGHTNESS ENHANCEMENT FILM

(76) Inventor: Dong-Yih Liou, Chung Li City (TW)

Correspondence Address: LEONG C LEI, PMB # 1008, 1867 YGNACIO VALLEY ROAD, WALNUT CREEK, CA, 94598, US

(21) Appl. No.: 12/040,929

(22) Filed: Mar. 3, 2008

(51) Int. Cl. F21V 5/02

(52) U.S. Cl. 362/340

(57) ABSTRACT

A brightness enhancement film comprising a plurality of closely arranged lens microstructures. Each lens microstructure has a cross section having an apex and two included side faces. At least one of the side faces forms a curved surface. The brightness enhancement film not only realizes light condensation but also optimizes brightness and viewing angle by means of the curved surface formed on at least one of the side faces of the cross section thereof.

### BACKGROUND OF THE INVENTION

(a) Technical Field of the Invention

The present invention relates to a brightness enhancement film, and in particular to a brightness enhancement film for use in a backlight module of liquid crystal display (LCD). The brightness enhancement film not only realizes light condensation but also optimizes brightness and viewing angle of the LCD.

(b) Description of the Prior Art

A conventional liquid crystal display comprises one or more lightness enhancement films interposed between the LCD panel and diffuser film or light guide plate in order to make the light that exits the light guide plate or the diffuser film refracted by the brightness enhancement film to condense to the front direction of the display, so that the brightness enhancement can be realized.

FIG. 1 of the attached drawings is a conventional brightness enhancement film (1), which comprises prism microstructures(2) properly arranged to cause refraction of the light exiting the light guide plate or the diffuser film so as to condense the light to the front direction of a display.

In the practical applications of the brightness enhancement films, the brightness enhancement film functions to enhance visual brightness of a display. However, condensation of the exiting light decreases the viewing angle of the display. The conventional brightness enhancement film is made up of prismatic microstructures wherein the prisms have inclined side surfaces of fixed angle so that when the incident light is received at a fixed angle, the exiting light is also emitted at a fixed angle. This imposes limitation to the viewing angle, and is thus not satisfactory for the needs of large viewing angle of large displays.

FIG. 2 shows another known brightness enhancement film (3), which is also made up of properly arranged prism microstructures (4), wherein the prisms have inclined side surfaces and a rounded apex section (5) so that the brightness enhancement film can function to both enhance the brightness and diffuse light to expand the range of viewing angle. However, the rounded section (5) is set at the top of the prism so that the location and curvature cannot be adjusted, to accommodate various incidence angle of the incident light to actually control the exiting angle of the exiting light. Thus, such a known brightness enhancement film may suffer either too low brightness or too small viewing angle and is incapable to provide satisfactory results for both brightness and viewing angle.

It is known that the success of commercial use of an invention relies not only on the realization of the desired function of such an invention, but also on the satisfactory of the product requirement. Thus, the present invention is aimed to provide a brightness enhancement film, which can satisfy the requirement of the large LCD products not only realizes light condensation but also optimizes brightness and viewing angle.

### SUMMARY OF THE INVENTION

The primary purpose of the present invention is to provide a brightness enhancement film, which comprises a plurality of closely arranged lens microstructures. Each lens microstructure has a cross section delimited by two inclined side faces on opposite sites of an apex, wherein one of the side faces comprises at least an arcuate or curved surface, or two side faces each comprises at least an arcuate or curved surface. Thus, the brightness enhancement film not only realizes light condensation but also optimizes brightness and viewing angle.

One of the factors that a brightness enhancement film may affect the viewing angle of a display is the shape of microstructure thereof. When the microstructures that make up the brightness enhancement film are of an identical configuration, the viewing angle of the display will be the same. Thus, when the configuration of the microstructures is different or variable, the viewing angle is also changed.

Based on the principle described above, the present invention provides a brightness enhancement film, which comprises a plurality of closely arranged lens microstructures. Each lens microstructure has a cross section delimited by two inclined side faces on opposite sites of an apex, wherein one of the side faces comprises at least an arcuate or curved surface, or two side faces each comprises at least an arcuate or curved surface. The location of arcuate surface and the curvature of curved surface can be adjusted to accommodate the incidence angle of the incident light so that the angular range of the exiting light can be controlled to provide a desired curve of brightness-viewing angle. Thus, the brightness enhancement film not only realizes light condensation but also optimizes brightness and viewing angle.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional brightness enhancement film;

FIG. 2 is an end view of another conventional brightness enhancement film;

FIG. 3 is a perspective view of a brightness enhancement film constructed in accordance with a first embodiment of the present invention;

FIG. 4 is a cross-sectional view of a portion of the brightness enhancement film of the first embodiment of the present invention, illustrating a convex side surface of each lens microstructure that constitutes the brightness enhancement film;

FIG. 5 is similar to FIG. 4 but showing a concave side surface of each lens microstructure that constitutes a modification of the brightness enhancement film of the first embodiment of the present invention;

FIG. 6 is a plane view showing another modification of the brightness enhancement film of the first embodiment of the present invention, illustrating the lens microstructures are of a left-and-right curved configuration;

FIG. 7 is a side elevational view showing a further modification of the brightness enhancement film of the first embodiment of the present invention, illustrating the lens microstructures are of an up-and-down wavy configuration;

FIG. 8 is a side elevational view showing a further modification of the brightness enhancement film of the first embodiment of the present invention, illustrating the lens microstructures are of alternating left-and-right curved configurations;

FIG. 9 is a partial end view of lens microstructures that make up a brightness enhancement film in accordance with a second embodiment of the present invention, illustrating a light diffusion structure added to the brightness enhancement film;

FIG. 10 is a partial end view of lens microstructures that make up a brightness enhancement film in accordance with a third embodiment of the present invention, illustrating arcuate surfaces are set on an upper portion of each lens microstructure of the brightness enhancement film;

FIG. 11 is a partial end view of lens microstructures that make up a brightness enhancement film in accordance with a fourth embodiment of the present invention, illustrating arcuate surfaces are set on a lower portion of each lens microstructure of the brightness enhancement film; and

FIG. 12 is a partial end view of lens microstructures that make up a brightness enhancement film in accordance with a fifth embodiment of the present invention, illustrating two arcuate surfaces are set on each side face of each lens microstructure of the brightness enhancement film.

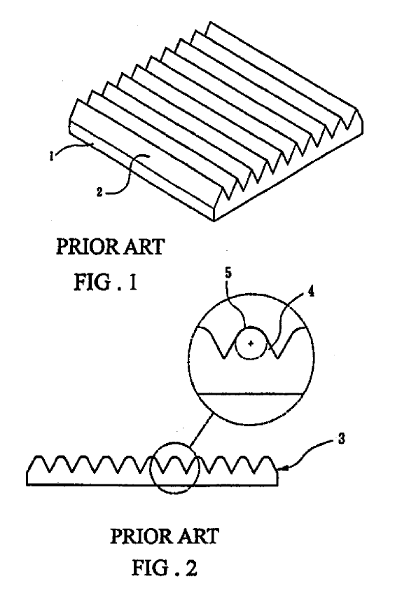

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

With reference to the drawings and in particular to FIG. 3, which shows a perspective view of a brightness enhancement film constructed in accordance with a first embodiment of the present invention, generally designated at (10), the brightness enhancement film (10) of the present invention comprises a plurality of lens microstructures (II) are closely arranged.

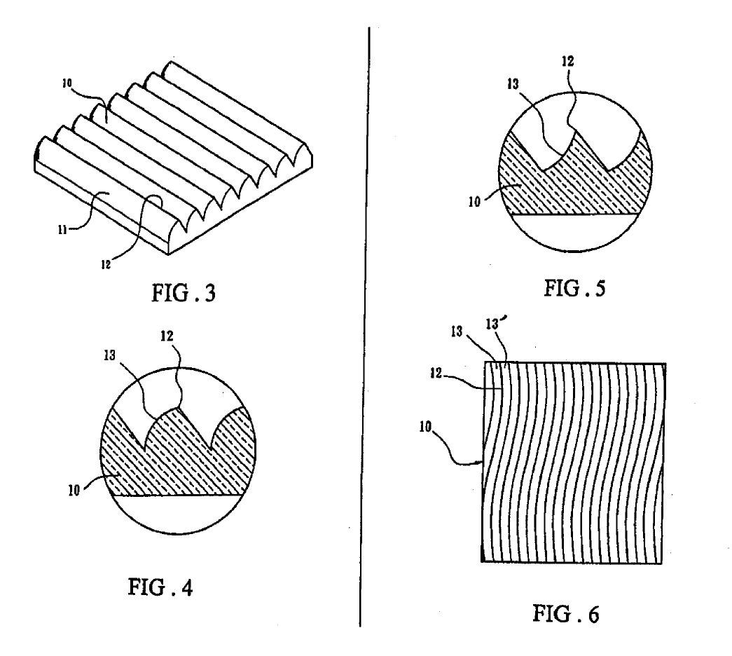

Also referring to FIG. 4, which shows a cross-sectional view of a portion of the brightness enhancement film of the present invention, each lens microstructure (II) has a cross section comprised of an apex (12) and two side faces that are substantially inclined and extend downward from the apex. One of the side faces is an inclined flat surface, while the other one forms a curved surface (13). In the embodiment illustrated, the curved surface (13) is a convex curved surface as clearly shown in FIG. 4. However, it is noted that the curved surface (13) can be made concave, as illustrated in the modification shown in FIG. 5.

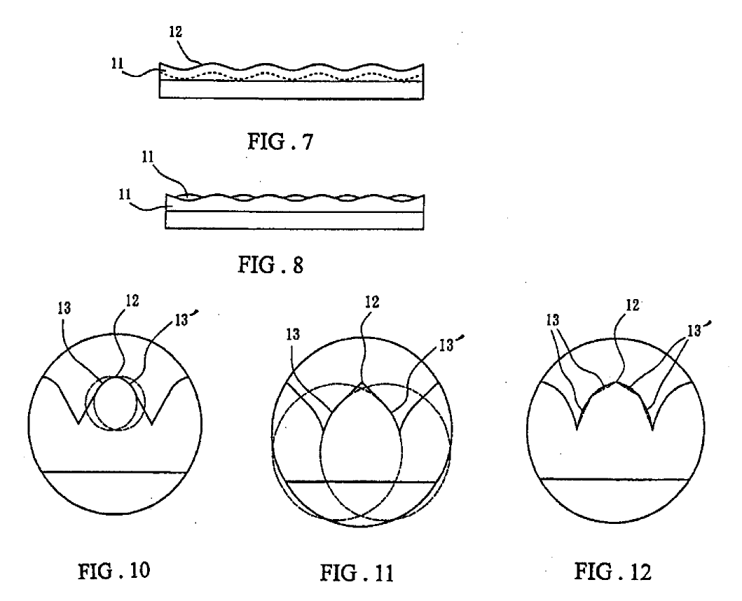

It is also noted that the lens microstructures can be set to extend straight in a linear configuration as shown in FIG. 3. Or, as shown in FIG. 6, the lens microstructures (11) can be of a left-and-right curved configuration and all the lens microstructures (11) are of the same left-and-right curved configuration. Or alternatively, as shown in FIG. 7, the lens microstructures (11) are of an up-and-down wavy configuration. Or, as a further alternative, the lens microstructures (11) can be of alternating up-and-down wavy configurations, with adjacent wavy configurations being out of phase. In the embodiment illustrated in FIG. 8, the waves are exactly out of phase, but it is apparent that they can be shifted by any fraction of a cycle or period so that adjacent wavy configurations are not exactly overlapped each other (in-phase) or out of phase in a side view.

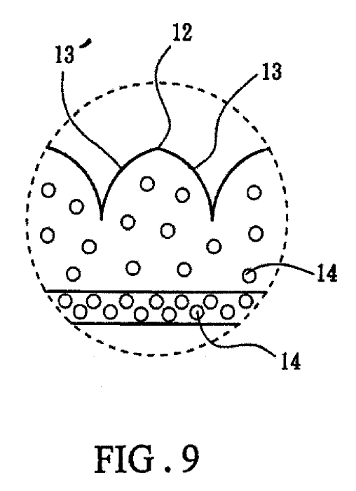

Referring to FIG. 9, which shows an end view of a portion of lens microstructures that make up a brightness enhancement film in accordance with a second embodiment of the present invention, the lens microstructures, also designated with reference numeral (11) for simplicity, each comprise a cross section having an apex (12) and two side faces that are substantially inclined. The two side faces are each made up of a curved surface (13), (13′). In the embodiment illustrated, the curved surfaces (13), (13′) are convex, yet it is obvious that the curved surfaces (13), (13′) can be concave.

If desired, an exiting light diffusion structure (14) can be added to the brightness enhancement film (10) to make the exiting light more uniform. The diffusion structure (14) can be integrally molded on the undersurface of the brightness enhancement film (10), or coated diffusion materials on the undersurface of the brightness enhancement film (10), or added diffusion materials into the brightness enhancement film (10).

Referring to FIG. 10, which shows an end view of a portion of lens microstructures that make up a brightness enhancement film in accordance with a third embodiment of the present invention, the lens microstructures, also designated with reference numeral (11) for simplicity, each comprise a cross section having an apex (12) and two side faces that are substantially inclined. Each side face forms a curved surface (13), (13′) on an upper portion thereof, while a lower portion thereof remains an inclined flat surface. Or, alternatively, as shown in FIG. 11, which illustrates an end view of a portion of lens microstructures that make up a brightness enhancement film in accordance with a fourth embodiment of the present invention, the lens microstructures, also designated with reference numeral (11) for simplicity, each comprise a cross section having an apex (12) and two side faces that are substantially inclined. Each side face forms a curved surface (13), (13′) on a lower portion thereof, while an upper portion thereof remains an inclined flat surface.

Referring to FIG. 12, which an end view of a portion of lens microstructures that make up a brightness enhancement film in accordance with a fifth embodiment of the present invention, the lens microstructures, also designated with reference numeral (11) for simplicity, each comprises a cross section having an apex (12) and two side faces that are substantially inclined. Each side face is composed of two segments each forming a curved surface (13), (13′) so that each side of the lens microstructure is composed of two curved surfaces (13), (13′).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A brightness enhancement film comprising a plurality of closely arranged lens microstructures. Each lens microstructure has a cross section delimited by two inclined side faces on opposite sites of an apex, wherein one of the side faces comprises at least an arcuate or curved surface, or two side faces each comprises at least an arcuate or curved surface.

2. The brightness enhancement film as claimed in claim 1, wherein the arcuate or curved surface is convex or concave.

3. The brightness enhancement film as claimed in claim 1, wherein each lens microstructure has a left-and-right curved configuration or an up-and-down wavy configuration.

4. The brightness enhancement film as claimed in claim 1, wherein the brightness enhancement film has a diffusion structure which integrally molded on the undersurface, or coated diffusion materials on the undersurface, or added diffusion materials into the brightness enhancement film.

5. The brightness enhancement film as claimed in claim 1, wherein each side face of the lens microstructure is composed of upper and lower segments of which at least one segment forms the arcuate or curved surface.
